(19) United States
(12) Patent Application Publication
(10) Pub. No.: US 2023/0188508 A1
(43) Pub. Date: Jun. 15, 2023

(54) VIDEO IMAGES FOR PLATOONING

(71) Applicant: Continental Automotive Systems, Inc., Auburn Hills, MI (US)

(72) Inventors: Ulrich Stählin, Eschborn (DE); Kenta Nakajima, Tokyo (JP)

(73) Assignee: Continental Automotive Systems, Inc., Auburn Hills, MI (US)

(21) Appl. No.: 17/643,475

(22) Filed: Dec. 9, 2021

(51) Int. Cl. G08G 1/0967; H04L 9/08; G08G 1/00

(52) U.S. Cl. CPC H04L 63/0428; G08G 1/096791; H04L 9/0838; G08G 1/22

(57) ABSTRACT

A disclosed vehicle communication system provides for sharing of live streaming images from the lead vehicle of the roadway forward of a vehicle platoon with all vehicles of the platoon. Sharing of forward looking images with other vehicles within the platoon provides information and a view that is similar to individual operation. The system further includes features for controlling what vehicles can receive the shared video images including encrypting the images to limit viewing to only those vehicles associated with the vehicle platoon

### TECHNICAL FIELD

The present disclosure relates to method and system for communicating images between vehicles in a platoon.

### BACKGROUND

Autonomously operated or assisted vehicles may form a group that travels down a roadway. Because the vehicles are traveling together, the safe distance from other vehicles can be reduced. The vehicles are linked in a manner that assures safe operation and enables closer following distances. Operators and passengers within the vehicles of the platoon are not all able to see ahead of the platoon. Accordingly, although operation is safe and controlled, passengers may still wish to know and see what is ahead and around the vehicle platoon.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method for communicating images within vehicles of a platoon according to a disclosed embodiment includes, among other possible things, identifying vehicles within a platoon, providing an encryption key to the identified vehicles within the platoon, obtaining images from at least one vehicle within the platoon, encrypting the images such that only vehicles with an encryption key may view the images, and

transmitting the encrypted images for viewing by operators within each of the identified vehicles in the platoon.

Another disclosed embodiment of the foregoing method includes obtaining images of a roadway ahead of the platoon from a lead vehicle within the platoon of vehicles.

In another disclosed embodiment of any of the foregoing methods, the lead vehicle encrypts the images and transmits the images.

In another disclosed embodiment of any of the foregoing methods, identifying vehicles within the platoon comprises pre-identifying vehicles prior to entering a roadway and providing an encryption key comprises forwarding an encryption key through a commonly accessible logistics portal.

In another disclosed embodiment of any of the foregoing methods, transmitting the encrypted images comprises transmitting the images directly from a lead vehicle to other vehicles within the platoon.

In another disclosed embodiment of any of the foregoing methods, identifying vehicles within the platoon comprises receiving a request to join the platoon from a vehicle proximate a lead vehicle of the platoon and communicating the encryption key from the lead vehicle in response to the request.

Another disclosed embodiment of any of the foregoing methods includes periodically changing the encryption key and communicating the changed encryption key to those vehicles identified as part of the vehicle platoon.

In another disclosed embodiment of any of the foregoing methods, the images comprises images of a roadway forward of a lead vehicle of the vehicle platoon.

In another disclosed embodiment of any of the foregoing methods, the images comprise a live streaming video of the roadway forward of a lead vehicle of the vehicle platoon.

In another disclosed embodiment of any of the foregoing methods, the images comprise a portion of a vehicle to vehicle communication signal and the encryption key is applicable only to the images.

A vehicle to vehicle communication system according to another disclosed example embodiment includes, among other possible things, a controller programmed to encrypt images, and a transceiver configured to communicate encrypted images with other vehicles identified as part of a vehicle platoon.

In another embodiment of the foregoing vehicle to vehicle communication system, the controller is programmed to communicate an encryption key to vehicles identified as part of the vehicle platoon, wherein the encryption key provides for viewing of the encrypted images.

In another embodiment of any of the foregoing vehicle to vehicle communication systems, the controller is programmed to periodically updated the encryption key and to communicate the updated encryption key with other vehicles identified as part of the vehicle platoon.

In another embodiment of any of the foregoing vehicle to vehicle communication systems, the controller is programmed to receive a request to join the vehicle platoon from another vehicle and to provide the other vehicle a means of obtaining an encryption key in response to accepting the request to join the vehicle platoon.

In another embodiment of any of the foregoing vehicle to vehicle communication systems, the controller is programmed to obtain and communicate video images of a roadway forward of a lead vehicle to other vehicles that are part of the vehicle platoon.

In another embodiment of any of the foregoing vehicle to vehicle communication systems, the transceiver is configured to transmit a vehicle to vehicle communication signal and the encryption key is applicable only to the images.

A computer readable storage medium including instructions for operating a vehicle to vehicle communication system according to another disclosed embodiment includes, among other possible things instructions for configuring a controller to identify vehicles within a platoon, instructions for operating the controller to provide an encryption key to the identified vehicles within the platoon, instructions for operating the controller to obtain images from at least one vehicle within the platoon, instruction for operating the controller to encrypt the images such that only vehicles with an encryption key may view the images, instructions for operating a transceiver to transmit the encrypted images for viewing by operators within each of the identified vehicles in the platoon.

Another embodiment of the foregoing computer storage readable medium includes instructions for operating the controller to obtaining images of a roadway ahead of the platoon from a lead vehicle within the platoon of vehicles.

Another embodiment of the foregoing computer storage readable medium includes instructions for operating the controller of a lead vehicle to encrypt and transmit the images of the roadway ahead of the platoon.

Another embodiment of the foregoing computer storage readable medium includes instructions for operating the controller to periodically change the encryption key and communicating the changed encryption key to those vehicles identified as part of the vehicle platoon.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example vehicle communication system for distributing images to vehicle platoon.

FIG. 2 is a schematic view an example view from a following vehicle within a vehicle platoon.

FIG. 3 is a schematic view of an example view from a lead vehicle within a vehicle platoon.

FIG. 4 is a schematic view of an example vehicle communication system.

FIG. 5 is a schematic view of example operation of a vehicle communication system for a vehicle platoon. method of accepting new vehicles within a vehicle platoon.

FIG. 6 is a flow diagram illustrating an example operation of a vehicle communication system for a vehicle platoon.

### DETAILED DESCRIPTION

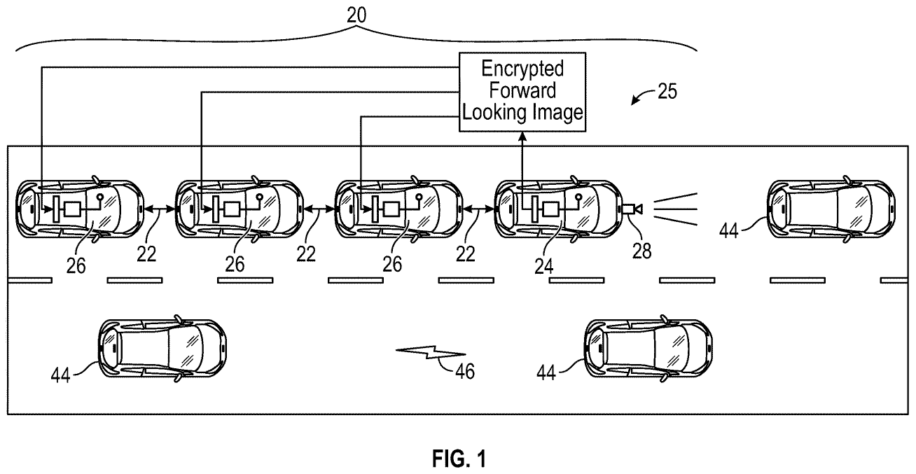

Referring to FIG. 1, a vehicle platoon 20 is shown schematically and includes a plurality of follower vehicles 26 following a lead vehicle 24 along a roadway 46. Follower vehicles 26 within the vehicle platoon 20 operate in concert with the lead vehicle 24 to improve individual vehicle operating efficiencies and to reduce traffic congestion. Such improvements are provided by operating the vehicles at common speeds in unison to reduce inefficiencies generated by individually operated vehicles. The vehicles 24, 26 within the vehicle platoon may be operated autonomously to provide operation according to different parameters as compared to individually and independently operated vehicles. One result of such operation is that vehicles 26 aft of the lead vehicle 24 may follow closer than would otherwise be comfortable to an individual operator. However, a closer following distance may not provide a comforting view of the roadway.

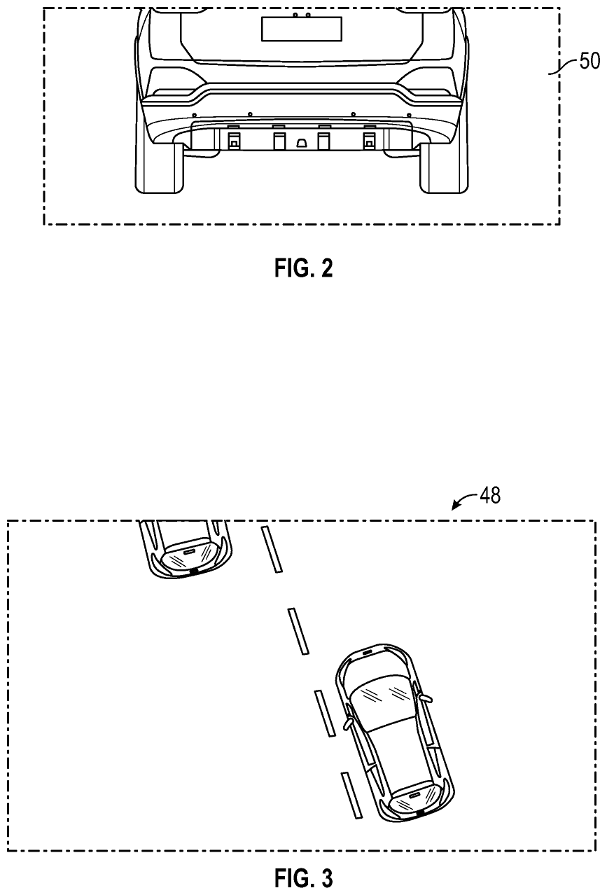

For example, referring to FIG. 2, a vehicle 26 aft of the lead vehicle 24 may provide passengers with little more than a view 50 of the back of the vehicle immediately in front.

Referring to FIG. 3 with continued reference to FIGS. 1 and 2, a disclosed example vehicle communication system 25 provides for sharing of live streaming images from the lead vehicle 24 of the roadway forward of the platoon 20, with all vehicles of the platoon. FIG. 3 is a schematic representation of a view from the lead vehicle 24 that is shared with vehicle platoon 20. Sharing of forward looking images with other vehicles within the platoon 20 provides information and a view that is similar to individual operation. The sharing of images with vehicles that are not part of the platoon is not necessary nor desirable. Therefore, the example system 25 further controls what vehicles can receive the shared video images by encrypting the images to limit viewing to only those vehicles associated with the vehicle platoon.

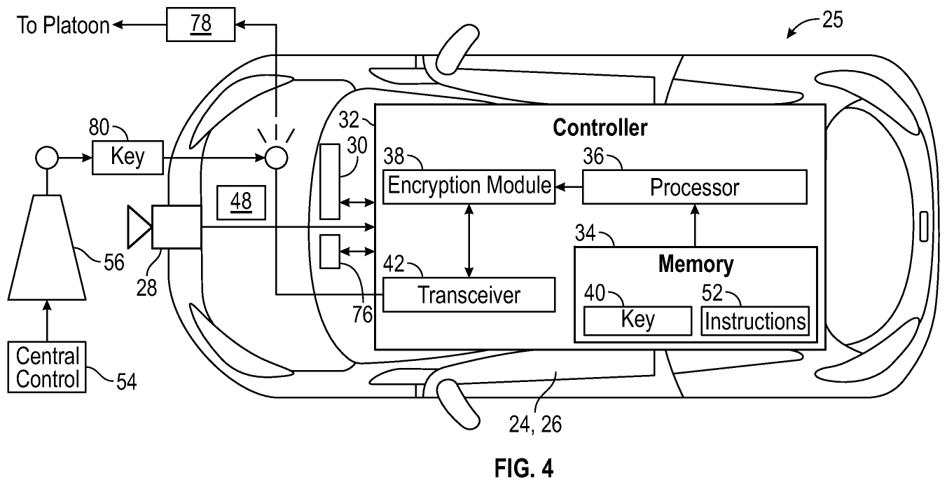

Referring to FIG. 4, with continued reference to FIGS. 1, 2 and 3, the example vehicle communication system 25 is schematically shown and is embodied in features that are mounted within each vehicle 24, 26. The system 25 may be completely embodied by a controller 32 mounted within the vehicle. The system 25 may also include a central control 54 located at a fixed location that communicates through a cellular or other wireless communication network schematically indicated at 56 with the vehicle mounted controller 32.

The vehicle mounted controller 32 is in communication with at least one camera 28 mounted on the vehicle. The vehicle mounted portion of the system will also be in communication with a display 30 that is a visible to passengers within the vehicle cabin. A human/machine interface 76 is also provided to provide for input and control of images viewable on the display 30.

In this example the camera 28 is forward facing to provide a view of the roadway forward of the platoon 20. The camera 28 may be disposed within the vehicle cabin or may be mounted to an exterior of the vehicle. Moreover, although a single camera 28 is shown by way of example, several cameras may be utilized and contribute to a forward looking image that is communicate to following vehicles. In any example instance, the images are actual live images rather than images produced using other sensor information.

The example controller 32 is a computing device configured and programmed for performing necessary computing or calculation operations. The controller 32 may be specially constructed for this purpose, or it may comprise at least a general-purpose processor selectively activated or reconfigured by a computer program. The controller 32 may be part of dedicated hardware for the example system 25 and/or part of an existing vehicle controller that also operates other features of the vehicle.

The example controller 32 includes a processor 36 and a memory device 34. The memory device 34 provides for storage of an encryption key 40 and instructions 52 for implementing operation and distribution of images. A transceiver 42 for sending and receiving transmissions from the vehicle to other vehicles or through the communication network 56 is also included. The transceiver 42 may be integrated with the controller 32 or may be a separate device in communication with the controller 32.

The encryption key 40 is distributed to each of the vehicles 24, 26 of the platoon 20. The controller 32 of each of the vehicles 24, 26 includes an encryption module 38 that uses the key 40 to encrypt and decrypt images communicated to the vehicle platoon 20. The encryption module 38 may be software executed by the processor 36 embodied in instructions saved in the memory 34. The encryption module 38 may use and perform encryption and decryption of images according to any known encryption protocol.

Operation of the example system 25 is initiated by communicating the key 40 with each of the vehicles 24, 26 of the platoon 20. Distribution of the key 40 may occur prior to the vehicles 24, 26 entering the roadway 46. In one example embodiment, each of the vehicles 24, 26, communicate with the central control 54 and are sent a key 80. The key 80 would be transmitted once a confirmation protocol is completed. The confirmation protocol would provide for identification of the vehicle and confirmation that the vehicle has agreed to securing and privacy restrictions. In this example, the central control 54 operates as a logistics portal to coordinate operation and formation of the vehicle platoon 20.

The central control 54 may be operated by a specific entity such as a trucking company or logistics operation that coordinates movement of goods between logistics centers. The central control 54 may also be a portal that coordinates many different independent operators that are proceeding along a common roadway. The central control 54 may also provide a portal to coordinate commuters proceeding to work during typical drive times. Although several embodiments of the central control are disclosed by way of example, other implementations of central control 54 could be utilized and are within the contemplation and scope of this disclosure in any implementation of the central control 54, the key 80 is communicated to provide a means of controlling and limiting distribution of images to the vehicle platoon 20.

Once the key 80 is distributed to vehicles 24, 26 of the vehicle platoon 20, it is saved and becomes the saved key 40 that is stored in the memory 34 within the vehicle 24, 26. The lead vehicle will use the key 40 along with the encryption module 38 to generate an encrypted image, schematically shown at 78, that is shared with other vehicles within the platoon 20. The camera 28 takes live images, schematically indicated at 48 encrypts the image 48 based on the encryption protocol and stored key 40 and sends the encrypted image 78 out to vehicles proximate the lead vehicle 24. Only those vehicles with the saved key 40 are able to receive and decrypt the images for viewing on the display 30.

The key 40 may be periodically updated to maintain privacy. In one example embodiment, updates to the key 40 are managed through communication through the network 56 by the central control 54. In another example embodiment, the encryption module 38 operates to update and change the key according to predefined protocols. It should be appreciated that any known encryption scheme and protocol, including those that periodically update such encryption could be utilized within the scope and contemplation of this disclosure.

In the disclosed example embodiment, the vehicles 24, 26 of the platoon 20 may communicate other information required to operate as a platoon 20. Such information may be distributed through the central control 54 or between vehicles as part of a vehicle to vehicle communication protocol. Other encryption protocols may be utilized for such communications. The disclosed example system 25 provides for communication security for the distributed images.

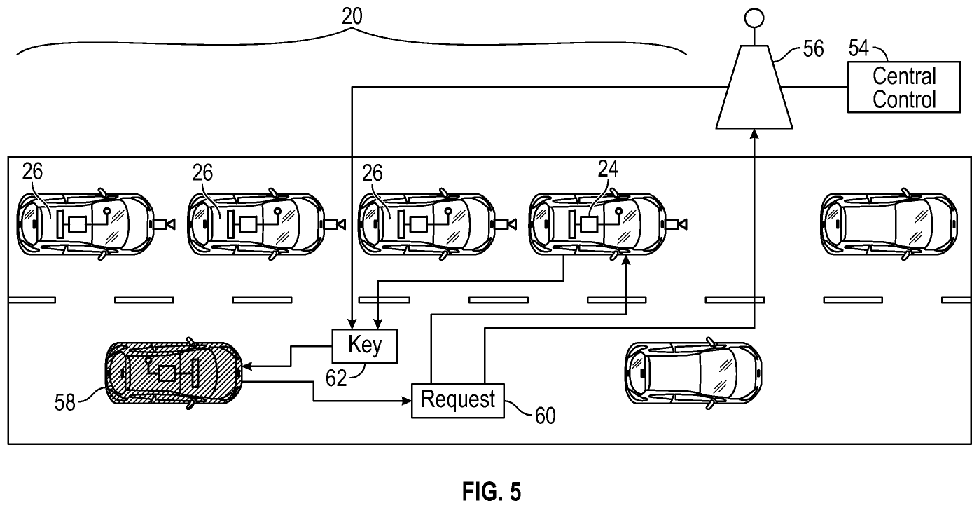

Referring to FIG. 5 with continued reference to FIGS. 1 and 4, another disclosed example embodiment provides for formation of the vehicle platoon 20 in real time along the roadway 46. In this example, the lead vehicle 24 receives a request 60 from a requesting vehicle 58. The request 60 may be sent directly to the lead vehicle 24 through a vehicle to vehicle communication protocol or channeled through the central control 54 through the communication network 56. In either case, the lead vehicle 24 is provided the request 60 and can accept the requesting vehicle 58 by communicating a key 62. The key 62 may be sent directly from the lead vehicle 24 or may be sent through the communication network 56 from the central control 54. The requesting vehicle 60 then stores the key 62 and is capable of decrypting the images sent from the lead vehicle 24.

The key 62 may be a separate communication or part of any communication that may be needed to coordinate joining and operation of the requesting vehicle 58 as part of the platoon 20. Moreover, circumstances may arise where the lead vehicle 24 may choose to share images with vehicles that are not part of the platoon 20 but have an interest in operation with the platoon 20. In such instances, the key 62 would be sent independent of any communication protocols necessary for operation of the vehicle platoon 20.

The example system 25 provides the operator of the lead vehicle 24 control of what and if images are transmitted to other vehicles within the platoon 20. In some instances, the lead vehicle 24 may include a camera 28 that produces images that may show features and occupants that are desired to be kept private during some operational times. In such instances, the operator of the lead vehicle 24 can select when and if such images are transmitted. Moreover, the lead, vehicle 24 may have multiple cameras that provide different views. The operator of the lead vehicle may then select which image to share with the platoon 20.

Additionally, the lead vehicle 24 may change as additional vehicles join or leave the vehicle platoon 20. Accordingly, each of the vehicles 20 may be provided with the capability of encrypting and transmitting images for the benefit of the vehicle platoon 20.

Although the example system 25 provides for the encryption of images, such encryption is not necessary for operation. In some instances, it may be beneficial to operation to share the forward looking images with vehicles within the platoon 20 and any vehicles proximate the platoon 20. Moreover, the images from the lead vehicle 24 may also provide benefit to operators at the central control 54 location. For platoons formed of trucks from a logistics organization, the sharing of images could provide information that provide for updated arrival times and to assure that vehicle operators are driving according to predefined guidelines.

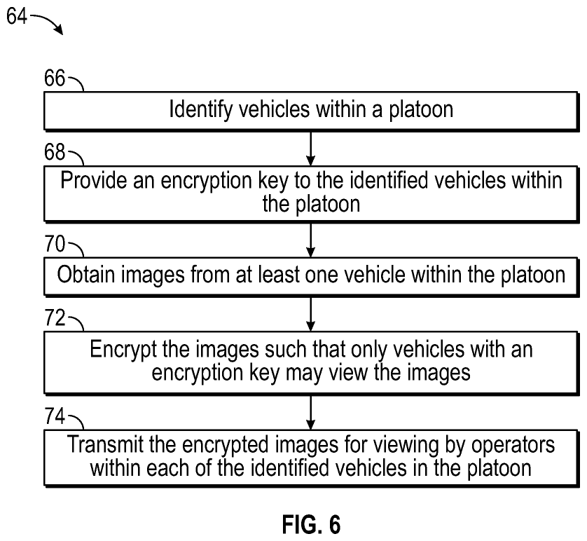

Referring to FIG. 6, with continued reference to FIGS. 1. and 4, operational steps are shown in a flow chart 64. The steps include an initial step of identifying vehicles that are to form the vehicle platoon 20 as indicated at 66. The identification step 66 may be executed prior to the vehicles entering the roadway through a central control 54. The identification step 66 may also be executed as the vehicles proceed down the roadway to accept new vehicles that desire to join the platoon 20.

Once the vehicles that are to form the platoon are identified, an encryption key 80 is communicated to each of the identified vehicles as is indicated at 68. In one example embodiment, the key 80 (FIG. 4) may be communicated from a central control through the communication network 56. In another example embodiment, a key 62 (FIG. 5) is communicated from one of the vehicles that are already part of the platoon 20, such as the lead vehicle 24.

At least one of the vehicles of the platoon 20 will obtain images as indicated at 70. In one example, the lead vehicle 24 obtains images of the roadway and traffic forward of the vehicle platoon 20. It should be appreciated that although images forward of the vehicle platoon 20 are shown and described by way of example, other images proximate to the environment proximate the vehicle platoon 20 may also be utilized and are within the scope and contemplation of this disclosure.

The images are then encrypted as schematically indicated at 72 utilizing an encryption protocol. In one example, the encryption protocol utilizes the saved encryption key 40 (FIG. 4) distributed to each of the vehicles of the platoon 20. Other encryption schemes, methods and protocols cold be utilized within the scope and contemplation of this disclosure.

The encrypted images are than transmitted from one of the vehicles 20 within the platoon 20 for viewing by operators and passengers as indicated at 74. The forward facing view provides a perspective of the roadway and traffic around the vehicle platoon 20 that may not be available and that is more familiar. The images may be other than forward facing to provide view of the roadway that are useful to all participants of the vehicle platoon 20.

The disclosed system and method is implemented by processing devices disposed within the vehicles that provide vehicle to vehicle communication. Such communication between vehicles can be implemented by any known communication protocol that has sufficient capability to transmit real time images. Examples of applicable communication protocols include WiFi, Bluetooth, Universal Mobile Telecommunication System (UMTS), Long Term Evolution (LTE), 5G, as well as other known cellular and wireless communication protocols.

The instructions 52 for configuring and operating the controller 32 and the processor 36 are embodied in software instructions that are stored on a computer readable medium. The computer readable medium may be embodied in structures such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. The disclosed computer readable medium may be a non-transitory medium such as those examples provided.

Moreover, the software instructions 52 may be saved in the memory 34. The disclosed memory device 34, may can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. The controller can be configured to execute software stored within the memory, to communicate data to and from the memory, and to generally control operations of the computing device pursuant to the software. Software in memory, in whole or in part, is read by the processor, perhaps buffered within the processor, and then executed.

Accordingly, the disclosed example vehicle communication system 25 provides for sharing of live streaming images with all vehicles of the platoon and further controls what vehicles can receive the shared video images by encrypting the images to limit viewing to only those vehicles associated with the vehicle platoon.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method for communicating images within vehicles of a platoon, the method comprising:
identifying vehicles within a platoon;
providing an encryption key to the identified vehicles within the platoon;
obtaining images from at least one vehicle within the platoon;
encrypting the images such that only vehicles with an encryption key may view the images; and
transmitting the encrypted images for viewing by operators within each of the identified vehicles in the platoon.

2. The method as recited in claim 1, including obtaining images of a roadway ahead of the platoon from a lead vehicle within the platoon of vehicles.

3. The method as recited in claim 2, wherein the lead vehicle encrypts the images and transmits the images.

4. The method as recited in claim 1, wherein identifying vehicles within the platoon comprises pre-identifying vehicles prior to entering a roadway and providing an encryption key comprises forwarding an encryption key through a commonly accessible logistics portal.

5. The method as recited in claim 1, wherein transmitting the encrypted images comprises transmitting the images directly from a lead vehicle to other vehicles within the platoon.

6. The method as recited in claim 1, wherein identifying vehicles within the platoon comprises receiving a request to join the platoon from a vehicle proximate a lead vehicle of the platoon and communicating the encryption key from the lead vehicle in response to the request.

7. The method as recited in claim 1, including periodically changing the encryption key and communicating the changed encryption key to those vehicles identified as part of the vehicle platoon.

8. The method as recited in claim 1, wherein the images comprises images of a roadway forward of a lead vehicle of the vehicle platoon.

9. The method as recited in claim 8, wherein the images comprise a live streaming video of the roadway forward of a lead vehicle of the vehicle platoon.

10. The method as recited in claim 1, wherein the images comprise a portion of a vehicle to vehicle communication signal and the encryption key is applicable only to the images.

11. A vehicle to vehicle communication system comprising:
a controller programmed to encrypt images; and
a transceiver configured to communicate encrypted images with other vehicles identified as part of a vehicle platoon.

12. The vehicle to vehicle communication system as recited in claim 11, wherein the controller is programmed to communicate an encryption key to vehicles identified as part of the vehicle platoon, wherein the encryption key provides for viewing of the encrypted images.

13. The vehicle to vehicle communication system as recited in claim 12, wherein the controller is programmed to periodically updated the encryption key and to communicate the updated encryption key with other vehicles identified as part of the vehicle platoon.

14. The vehicle to vehicle communication system as recited in claim 11, wherein the controller is programmed to receive a request to join the vehicle platoon from another vehicle and to provide the other vehicle a means of obtaining an encryption key in response to accepting the request to join the vehicle platoon.

15. The vehicle to vehicle communication system as recited in claim 11, wherein the controller is programmed to obtain and communicate video images of a roadway forward of a lead vehicle to other vehicles that are part of the vehicle platoon.

16. The vehicle to vehicle communication system as recited in claim 12, wherein the transceiver is configured to transmit a vehicle to vehicle communication signal and the encryption key is applicable only to the images.

17. A computer readable medium including instructions for operating a vehicle to vehicle communication system, the computer readable medium comprising:
instructions for configuring a controller to identify vehicles within a platoon;
instructions for operating the controller to provide an encryption key to the identified vehicles within the platoon;
instructions for operating the controller to obtain images from at least one vehicle within the platoon;
instruction for operating the controller to encrypt the images such that only vehicles with an encryption key may view the images; and
instructions for operating a transceiver to transmit the encrypted images for viewing by operators within each of the identified vehicles in the platoon.

18. The computer readable medium including instructions for operating a vehicle to vehicle communication system as recited in claim 17, further including instructions for operating the controller to obtaining images of a roadway ahead of the platoon from a lead vehicle within the platoon of vehicles.

19. The computer readable medium including instructions for operating a vehicle to vehicle communication system as recited in claim 17, including instructions for operating the controller of a lead vehicle to encrypt and transmit the images of the roadway ahead of the platoon.

20. The computer readable medium including instructions for operating a vehicle to vehicle communication system as recited in claim 17, including instructions for operating the controller to periodically change the encryption key and communicating the changed encryption key to those vehicles identified as part of the vehicle platoon.
